(19) United States
(12) Patent Application Publication
(10) Pub. No.: US 2008/0302993 A1
(43) Pub. Date: Dec. 11, 2008

(54) Fluid valve arrangement

(76) Inventor: Ernst Bigler, Wiesendangen (CH)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 12/156,704

(22) Filed: Jun. 4, 2008

(30) Foreign Application Priority Data
Jun. 8, 2007 (DE) 10 2007 026 698.9

(51) Int. Cl. F16K 1/00

(52) U.S. Cl. 251/324

(57) ABSTRACT

A fluid valve arrangement (10) having a valve housing (11), which has at least one passage (14, 15, 16) for the fluid (F), and having a valve body (12), which is arranged movably in the valve housing (11), for opening and closing the fluid passage (14, 15, 16), the valve body (12) being movable to and fro in the valve housing (11) between two closing positions and, in the central positions between the closing positions, freeing the fluid passage (14, 15, 16).

The invention relates to a fluid valve arrangement having a valve housing, which has at least one passage for the fluid, and having a valve body, which is arranged movably in the valve housing, for opening and closing the passage.

Such valves for opening and closing a passage for a gas or a liquid are already known in a variety of forms. The valve body of these valves can be moved to and fro between a closing position, in which it blocks the passage, and an opening position, in which it frees the passage. Therefore a change of direction of the valve body is necessary to open the valve and close it again. These known valves therefore require a relatively long switching time.

DE 630 06 091 T2, EP 0 233 025 and JP 01229176 A disclose 312- way vales, each of which has a valve body having two valve discs which, depending on the position of, close one of two valve seats provided. By moving the valve body to and fro between the closing positions of the valve seats, the passage of the fluid can be switched to other paths. It is not possible to block these valves completely.

DD 48274 describes a similar 312-way valve in which, as a result of a valve body being moved to and fro by means of the fluid, two closing positions are reached in which the valve is completely blocked. However, this occurs only when a fluid flows from only one of the two inlets. When fluid flows in from both inlets simultaneously, a flow always results at the outlet as well.

The object of the present invention is to provide a valve arrangement for fluids which requires only short switching times for opening and closing.

### SUMMARY OF THE INVENTION

The object is achieved with a fluid valve arrangement having the features of claim 1.

In the case of this valve arrangement, the valve body does not have to change direction in order to open the valve and close it again. Therefore, with the valve arrangement according to the invention, markedly higher switching rates can be achieved than with known valves.

Especially in the case of applications where relatively large amounts of fluid have to be released for only a brief period, the valve arrangement according to the invention provides advantages over conventional valves. While the known valves, as a result of the necessary change of direction on switching, have a minimum opening and closing time which is often longer than necessary for the particular application, an unnecessarily large amount of fluid and therefore energy is consumed. Owing to the markedly shorter switching times in the case of the valve arrangement according to the invention, this disadvantage can be avoided.

The object of the present invention is to provide a valve arrangement for fluids which requires only short switching times.

The object is achieved with a fluid valve arrangement having a valve housing, which has at least one passage for the fluid, and having a valve body, which is arranged movably in the valve housing, for opening and closing the passage, which arrangement is characterised according to the invention in that the valve body is movable to and fro in the valve housing between two closing positions, and, in the central positions between the closing positions, frees the fluid passage.

In the case of this valve arrangement, the valve body does not have to change direction in order to open the valve and close it again. Therefore, with the valve arrangement accoring to the invention, markedly higher switching rates can be achieved than with known valves.

Especially in the case of applications where relatively large amounts of fluid have to be released for only a brief period, the valve arrangement according to the invention provides advantages over conventional valves. While the known valves as a result of the necessary change of direction on switching, have a minimum opening and closing time which is often longer than necessary for the particular application, an unnecassarily large amount of fluid and therefore energy is consumed. Owing to the markedly shorter switching times in the case of the valve arrangement according to the invention, this disadvantage can be avoided.

It is possible to carry out the geometric configuration of the valve housing and of the valve body in various manners. In a preferred variant of the valve arrangement, the valve housing is cylindrical, at least on the inside, and the valve body is piston-shaped. This means that the valve body is moved linearly in the valve housing, which permits especially high switching rates.

Further advantages result when the valve body has a central region which is reduced in diameter and which, in the central positions of the valve body, is located in the region of the fluid passage. Owing to its small diameter, this central region does not hinder the volume flow of the fluid in the passage when the valve body is in the opening position.

The fluid passage in the valve housing can preferably be formed by inlet and outlet openings in the valve housing and by the surrounding area of the central region of the valve body. In the central positions of the valve body, the openings in the valve housing are not closed by the valve body, so that the fluid can flow unhindered through the valve housing.

In a preferred embodiment, the inlet and outlet openings can be arranged in the valve housing in such a manner that they are offset relative to each other in the direction of movement of the valve body. As a result it is sufficient, in the closing positions of the valve body, to close either only the inlet opening or only the outlet opening in order to block the entire valve. The valve body therefore has to perform only a slight stroke, as a result of which the switching rate can be further increased. In each case it is possible to provide only one or also several inlet openings and outlet openings.

In an advantageous development, the inlet and outlet openings can also be arranged at different circumferential sites, preferably at opposite circumferential sites in the valve housing. If the openings are arranged opposite each other, the fluid flows straight through the valve housing. If the inlet opening and the outlet opening are arranged at a specific angle to each other, a deflection of the fluid flow occurs through the valve housing when the valve is open.

Advantageously, at the transitions from the central region to the end regions of the valve body, sealing sites can be arranged between the valve body and a portion of the valve housing of reduced inside diameter in order to ensure that the valve is reliably closed. Further sealing sites can of course be provided between the valve body and the valve housing, especially when the valve body is driven pneumatically or hydraulically.

If the valve housing has a cylindrical configuration and the valve body is piston-shaped, resilient sealing bodies can advantageously be arranged at the sealing sites.

Further advantages result when the valve body is slidingly movable with its end regions on the inner surface of the valve housing, that is to say, only slight friction losses occur when the valve body moves.

In the region of the slide faces, seals can be provided between the valve body and the valve housing in order to prevent leakage.

In principle, any drive means used in valves can also be used for the valve arrangement according to the invention. For example, the valve body may be movable pneumatically, hydraulically, electromagnetically or by an electrical motor.

It is also advantageous to construct the valve as an insert which can be placed very close to the operating site. As a result, extremely short reaction times can be achieved. Furthermore, the valve can be manufactured from very simple components.

It is also possible to use several valves with opposite directions of operation in order to be able to compensate for differences in the reaction speed.

The area of use of the valve arrangement according to the invention is extremely wide. The valve arrangement can be used with advantage in any application where a large volume flow of a fluid and short switching times are desired for a brief period.

Thus, the valve arrangement can be used, for example, as a compressed-air valve in textile machines. The use of the valve arrangement offers advantages in several situations, especially in the case of looms. Owing to the valve arrangement, for example, a blast of compressed air which accelerates a shuttle carrying the weft thread through the shed can be released.

A further possible application in an air jet loom is the actuation of the so-called relay nozzles which keep the beginning of the weft thread stretched and in the desired position by means of compressed air. These nozzles are arranged in a manner distributed over the entire length of the weft insertion region and cause a critical portion of the energy consumption of an air jet loom. The electromagnetically switched valves used hitherto to actuate the relay nozzles, with a change of direction of the valve body between the opening position and the closing position of the valve, are open too long for this application and therefore consume an unnecessarily large amount of compressed air and therefore energy.

### BRIEF DESCRIPTION OF THE DRAWINGS

A preferred embodiment of a valve arrangement according to the invention is described in more detail hereinafter with reference to the drawings.

FIG. 1 is a longitudinal section through a valve arrangement in a first closing position;

FIG. 2 is a longitudinal section corresponding to FIG. 1 through the valve arrangement in an opening position;

FIG. 3 is a longitudinal section corresponding to FIG. 1 through the valve arrangement in a second closing position.

### DETAILED DESCRIPTION

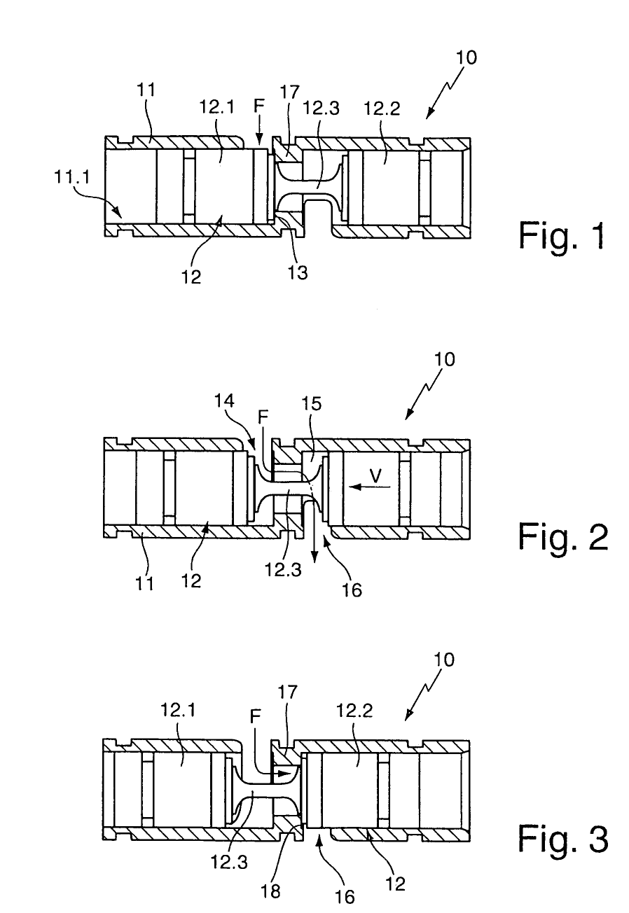

FIGS. 1 to 3 show an exemplary form of a valve arrangement 10 having a cylindrical valve housing 11 and a valve body 12 which is arranged in the valve housing 11 and which is shown in different positions in FIGS. 1 to 3. The valve body 12 has two end regions 12.1 and 12.2 which have an outside diameter corresponding to the unobstructed inside diameter of the valve housing 11. With these end regions 12.1 and 12.2, the valve body 12 can slide along the inner surface 11.1. Between the two end regions 12.1 and 12.2, the valve body 12 has a central region 12.3 which is markedly reduced in diameter compared with the end regions 12.1 and 12.2.

In FIG. 1, the valve body 12 is in a first closing position. Together with the valve housing 11, the valve body 12 forms a first sealing site 13 at the transition from the end region 12.1 to the central region 12.3, which abuts a portion 17 of reduced inside diameter in the valve housing 11. This sealing site 13 prevents the flow of a fluid F through the valve housing 11.

In FIG. 2, the valve body 12 has been accelerated in the direction of arrow v, as a result of which the sealing site 13 has been freed. The fluid F can now flow through a passage 15 in the valve housing 11, which passage is formed by an inlet opening 14, the surrounding area 15 of the central region 12.3 of the valve body in the valve housing 11, and an outlet opening 16. The inlet opening 14 and the outlet opening 16 are arranged on opposite sides of the valve housing 11 and in such a manner that they are offset relative to each other in the direction of movement of the valve body 12, the portion 17 of the valve housing 11 of reduced inside diameter being located between the inlet opening 14 and the outlet opening 16.

On further movement in the direction of arrow v, the valve body 12 reaches its second closing position, as shown in FIG. 3. The transition between the end region 12.2 and the central region 12.3 of the valve body 12 now abuts the portion 17 of the valve housing 11 of reduced inside diameter and thus forms a second sealing site 18. The outlet opening 16 is closed by the end region 12.2, so that no fluid F can flow through the valve housing 11.

The valve arrangement 10 is therefore opened and closed again by movements of the valve body 12 in a single direction. The switching time of the valve arrangement 10 is therefore only approximately half as long as the switching time of conventional valves where the valve body undergoes a change in direction between opening and closing.

1. Fluid valve arrangement having a valve housing (11), which has at least one passage (14, 15, 16) for the fluid (F), and having a valve body (12), which is arranged movably in the valve housing (11), for opening and closing the fluid passage (14, 15, 16), characterised in that the valve body (12) is movable to and fro in the valve housing (11) between two closing positions, and, in the central positions between the closing positions, frees the fluid passage (14, 15, 16).

2. Valve arrangement according to claim 1, characterised in that the valve housing (11) is cylindrical, at least on the inside, and the valve body (12) is piston-shaped.

3. Valve arrangement according to claim 1 or 2, characterised in that the valve body (12) has a central region (12.3) which is reduced in diameter and which, in the central positions of the valve body (12), is located in the region of the fluid passage (14, 15, 16).

4. Valve arrangement according to claim 3, characterised in that the fluid passage (14, 15, 16) is formed by inlet and outlet openings (14, 16) in the valve housing (11) and by the surrounding area (15) of the central region (12.3) of the valve body (12).

5. Valve arrangement according to claim 4, characterised in that the inlet and outlet openings (14, 16) are arranged in the valve housing (11) in such a manner that they are offset relative to each other in the direction of movement of the valve body (12).

6. Valve arrangement according to claim 4 or 5, characterised in that the inlet and outlet openings (14, 16) are arranged at different circumferential sites, preferably at opposite circumferential sites in the valve housing (11).

7. Valve arrangement according to any one of claims 3 to 6, characterised in that, at the transitions from the central region (12.3) to the end regions (12.1, 12.2) of the valve body (12), sealing sites (13, 18) are arranged between the valve body (12) and a portion (17) of the valve housing (11) of reduced inside diameter.

8. Valve arrangement according to claim 7, characterised in that resilient sealing bodies are arranged at the sealing sites (13, 18).

9. Valve arrangement according to any one of claims 3 to 8, characterised in that the valve body (12) is slidingly movable with its end regions (12.1, 12.2) on the inner surface (11.1) of the valve housing (11).

10. Valve arrangement according to claim 9, characterised in that, in the region of the slide faces, seals are provided between the valve body (12) and the valve housing (11) in order to prevent leakage.

11. Valve arrangement according to any one of the preceding claims, characterised in that the valve body (12) is movable pneumatically, hydraulically, electromagnetically or by an electrical motor.
